(19) United States
(12) Patent Application Publication
(10) Pub. No.: US 2014/0095311 A1
(43) Pub. Date: Apr. 3, 2014

(54) Pizza Sales Promotion

(71) Applicant: Paul Milner "Chip" Bulloch, JR., Atlanta, GA (US)

(72) Inventor: Paul Milner "Chip" Bulloch, JR., Atlanta, GA (US)

(21) Appl. No.: 13/630,648

(22) Filed: Sep. 28, 2012

(51) Int. Cl. G06Q 30/02

(52) U.S. Cl. 705/14.55; 705/14.58

(57) ABSTRACT

A process for promoting sales of a food item. The process may include receiving an order for an ordered food item to be delivered to a first location and sending a vehicle with the ordered food item towards the first location. The process may include sending one or more secondary food items along with the vehicle, preparing a list of the one or more secondary food items, preparing a list of one or more customers, and broadcasting a first message including the list of secondary food items to one or more customers on the list of one or more customers.

### BACKGROUND OF THE INVENTION

Millions of people enjoy consuming pizza on a regular basis in the United States and countries around the world. Consumers can prepare pizza in an oven at home. Consumers can also opt to dine in a local pizza restaurant or have pizza delivered to residential, business or other locations.

Pizza delivery operations are often somewhat passive. While some pizza restaurants spend a lot of resources in promotion, little happens to actually move a pizza until that customer calls and orders a pizza for delivery. Current attempts to make pizza delivery more productive have been largely unsuccessful. There remains a long-felt need for a suitable means of optimizing pizza delivery operations and promoting sales and distribution.

### BRIEF DESCRIPTION OF THE DRAWINGS

FIG. 1 is a schematic view of a pizza distribution operation in accordance with an embodiment of the present invention.

FIG. 2 is a topological view of a plot of land subdivided into zones, that could be employed with the operation shown in FIG. 1.

### SUMMARY OF INVENTION

There is provided a process for promoting sales of a food item. The process may include receiving an order for an ordered food item to be delivered to a first location and sending a vehicle with the ordered food item towards the first location. The process may include sending one or more secondary food items along with the vehicle, preparing a list of the one or more secondary food items, preparing a list of one or more customers, and broadcasting a first message including the list of secondary food items to one or more customers on the list of one or more customers.

### DETAILED DESCRIPTION OF THE INVENTION

Preliminarily, it should be noted that certain terms used herein, such as for example above, below, upper, lower, left and right, are used to facilitate the description of the invention. Unless otherwise specified or made apparent by the context of the discussion, such terms and other directional terms should be interpreted with reference to the figure(s) under discussion. Such terms are not intended as a limitation on the position in which the invention or components may be used. Indeed, it is contemplated that the components of the invention may be easily positioned in any desired orientation for use. Likewise, numerical terms such as for example “first”, and “second” are not intended as a limitation or to imply a sequence, unless otherwise specified or made apparent by the context of the discussion. The term “operatively connected” is understood to include a linking together of the portions under consideration and may include a physical engagement and/or a functional or operational connection.

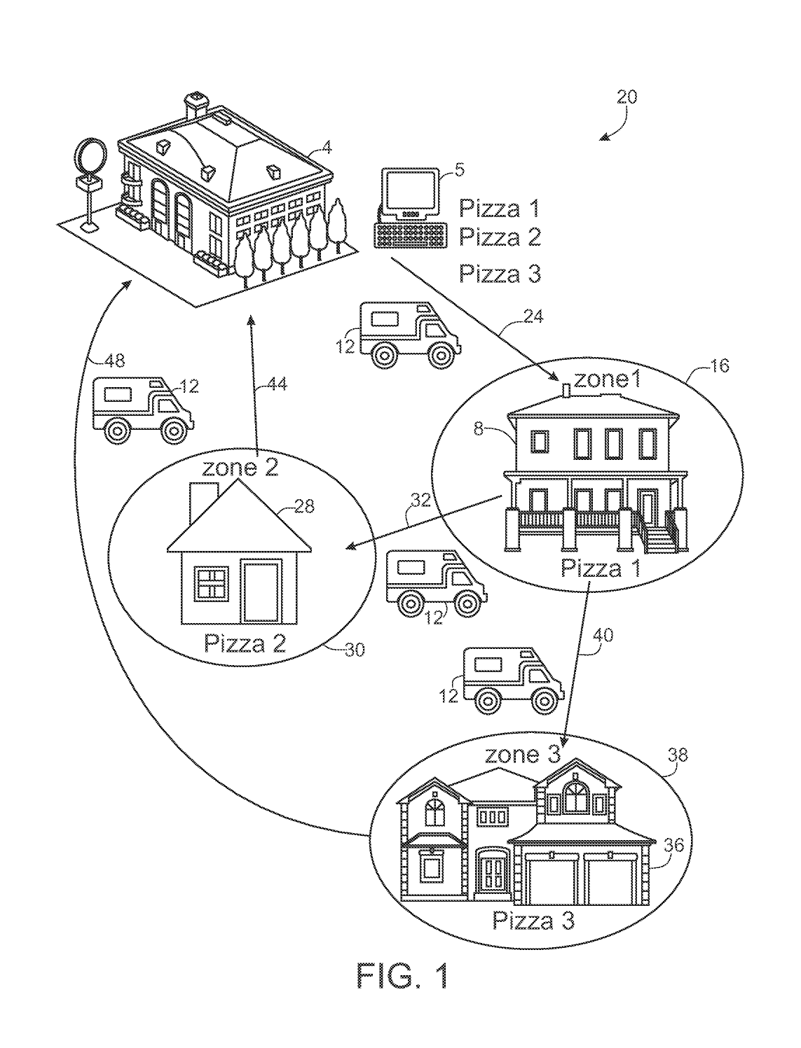

Referring now to the drawings, there is illustrated in FIGS. 1 a schematic representation of elements of the system, indicated generally at 20, according to the invention. While the system 20 may be described as working with a pizza delivery operation, other items of food may be included with or substituted for pizza.

Referring now to FIG. 1, elements of the system are indicated generally at 20. A restaurant is shown generally at 4. The restaurant 4 may be a delivery-based operation or some suitable combination of dine-in and delivery-based. Pizza is prepared at the restaurant 4. The restaurant 4 may be provided at a fixed location or may be mobile as desired. Pizza may be prepared at the request of a customer for delivery to the customer at a location away from the restaurant 4. A request may come to the restaurant 4 or some other location as desired.

Referring still to FIG. 1 as an example, assume that a customer provides a request for pizza1 to be delivered to location Delivery1 8, as generally indicated by arrow 24. A vehicle 12 may leave the restaurant 4 with pizza1, pizza2, and pizza3. Of course, any suitable numbers of pizzas may be employed. For purposes of clarity, pizza2 and pizza3 are what might be described as “speculation pizza” inasmuch as they were not specifically ordered by a customer—unlike pizza1.

FIG. 1 shows three pizzas merely for ease of discussion and understanding. When the vehicle 12 initially leaves the restaurant 4 with pizza1, pizza2, and pizza3, it may be that only the destination of pizza1 is known—Delivery1. The exact destinations for pizza2, and pizza3 may be initially unknown, but determined while the vehicle 12 is in transit. Pizza2, and pizza3 may be returned to the restaurant 4 and/or wasted or delivered to a customer at no charge to the customer. There is perhaps some matter and amount of risk in preparing pizza2, and pizza3.

How might the compositions of pizza2, and pizza3, such as for example type of pizza crust and pizza toppings, be determined? There may be a number of suitable ways, some discussed here. They may be the most commonly ordered type of pizza—in terms of pizza crust and pizza toppings. They may be the least expensive type of pizza. The system 20 or its operator (not shown) may have some type of gut feeling based on experience as to the type of pizza that might be most likely to be purchased. One or more databases may be created, implemented, maintained, and employed to assist in determining the compositions of pizza2, and pizza3. The databases may use a wide variety of data types, including for example demographics, previous sales, consumer responses to advertising campaigns, and the like.

Referring still to FIG. 1 as an example, as the vehicle 12 moves from the restaurant 4 to the location Delivery1 8, the vehicle 12 moves generally into zone1 16, as shown. The term “vehicle” as used in this application may be understood to include, but is not limited to, any device or structure for transporting persons or things; a conveyance. The term “zone” as used in this application may be understood to include, but is not limited to, any area or a region distinguished from adjacent parts by a distinctive feature or characteristic. The distinctive feature or characteristic of zone1 16 is its general proximity to location Delivery1 8.

As the vehicle 12 moves generally into zone1 16, or when vehicle 12 stops at location Delivery1 8, a broadcast of sorts may begin. The term “broadcast” as used in this application may be understood to include, but is not limited to, any transmission of a message or signal. The broadcast may originate or emanate from the vehicle 12 or the restaurant 4 or any other suitable source or location. The broadcast may include a text message, an e-mail message, telephone message, or the like. The broadcast may also begin when the vehicle 12 moves to the location Delivery1 8—any other suitable location or zone—as discussed herein. A text message is a type of a broadcast or broadcast message. Sending a text is one way to broadcast a message.

The content of the broadcast could include the availability and descriptor of pizza2 and pizza3. For example, the broadcast might include the price and pizza crust and pizza toppings for pizza2 and pizza3. Where the system 20 employed global positioning system data or the like, the broadcast might include the estimated time of delivery for pizza2 and pizza3 to the recipient.

For purposes of illustration, one broadcast transmission might include a text messages to recipients that might read something like, “Your favorite pizza maker is in the area making delivery. We can deliver to you a twelve inch thin crust pizza with cheese and pepperoni for $8.99 or a nine inch deep dish pizza with cheese only for $7.99. We can be at your location of 123 Main Street in six minutes. Return a text message of 123 to get the first pizza or a text of 456 to get the second pizza.”

Optimization of the zone size(s), shapes, borders, and locations may ensure that the system 20 does not initiate the broadcast too soon or too late. We might presume that consumers want their food delivered as soon as possible. A delay or wait of more then thirty to forty (30-40) minutes to have a pizza delivered can begin to test the consumer's patience. Such a delay or wait could also be a reason for the consumer not to make a delivery call to the restaurant 4.

If the broadcast begins immediately after the vehicle 12 leaves the restaurant 4, the consumer may wait well in excess of thirty minutes while the vehicle first attempts to deliver pizza1 to location Delivery1 8. For example, when waiting for a pizza2 to be delivered to location Delivery2 28 may include the full trip from the restaurant 4 to the location Delivery1 8, and then also include the full trip from the location Delivery1 8 to location Delivery2 28 as indicated generally by the arrow 32, the wait may be well in excess of thirty minutes.

However when the vehicle 12 is too close to a potential delivery location, the broadcast may prove to be less effective or entirely ineffective. Consider the potential outcome when the vehicle 12 delivers pizza1 to location Delivery1 8 and does not begin a broadcast concerning pizza2 and pizza3 until after leaving location Delivery1 8. Even assuming that a consumer at location Delivery2 28 might want pizza2, the broadcast message may indicate that the pizza2 can be delivered to location Delivery2 28 in one or two minutes. This short amount of time may not even be received and a decision made by the consumer at location Delivery2 28 until the vehicle 12 is well past location Delivery2 28 and returning to the restaurant 4.

In another embodiment, the vehicle may be deployed with pizza1, pizza2 and pizza3 without any customer request being made. Restaurants near high demand areas, such as colleges and universities and business parks, might consider this approach. Similarly, at times where demand for pizza might be perceived to be particularly high for some reason, the vehicle may be deployed with pizza1, pizza2 and pizza3 without any customer request being made in order to set the vehicle in motion. For example, if Friday and Saturday evenings are times in which there are believed to be high demand for pizza, the vehicle may be deployed with pizza1, pizza2 and pizza3 without any customer request being made in order to set the vehicle in motion. In such situations, the delivery rate limiting step may be more likely the production rate of the restaurant and not the type and number of consumer requests to initiate use of the vehicle.

Referring still to FIG. 1, after delivering pizza 1 to location Delivery1 8, the vehicle 12 may drive to location Delivery2 28 to deliver pizza 2 as indicated generally by the arrow 32. Similarly, the vehicle 12 may drive to location Delivery3 36 as indicated generally by the arrow 40. Note that location Delivery3 36 may be provided in zone 3 38, as shown in FIG. 1. The route selected for the vehicle 12 may be based in whole or in part on the response to the broadcast initiated in or around zone1 16. The relative distances between location Delivery1 8 and location Delivery2 28 and location Delivery3 36 may be taken into account in selection delivery sequence. Distances to and from any given location and the restaurant 4 may be considered. Pragmatic considerations such as the dollar value of each delivery may also be taken into account in selection delivery sequence. Of course, the observance of traffic laws and road conditions, such as for example speed limits, one-way streets, railroad crossings and the like, can be taken into account in selection delivery sequence. The location Delivery2 28 and the location Delivery3 36 may be a second location. Note that location Delivery2 28 may be provided in zone2 30, as shown on FIG. 1.

For purposes of simplicity, FIG. 1 does not show an arrow directly between location Delivery2 28 and location Delivery3 36. The vehicle 12 could travel such a route as desired. FIG. 1 does show an arrow 44 indicating a direct route from location Delivery2 28 and the restaurant 4. FIG. 1 does show an arrow 48 indicating a direct route from location Delivery3 36 and the restaurant 4. In practice, the vehicle may employ more than three pizzas on any particular departure from the restaurant 4. In practice, the vehicle may visit more than three delivery locations on any particular departure from the restaurant 4.

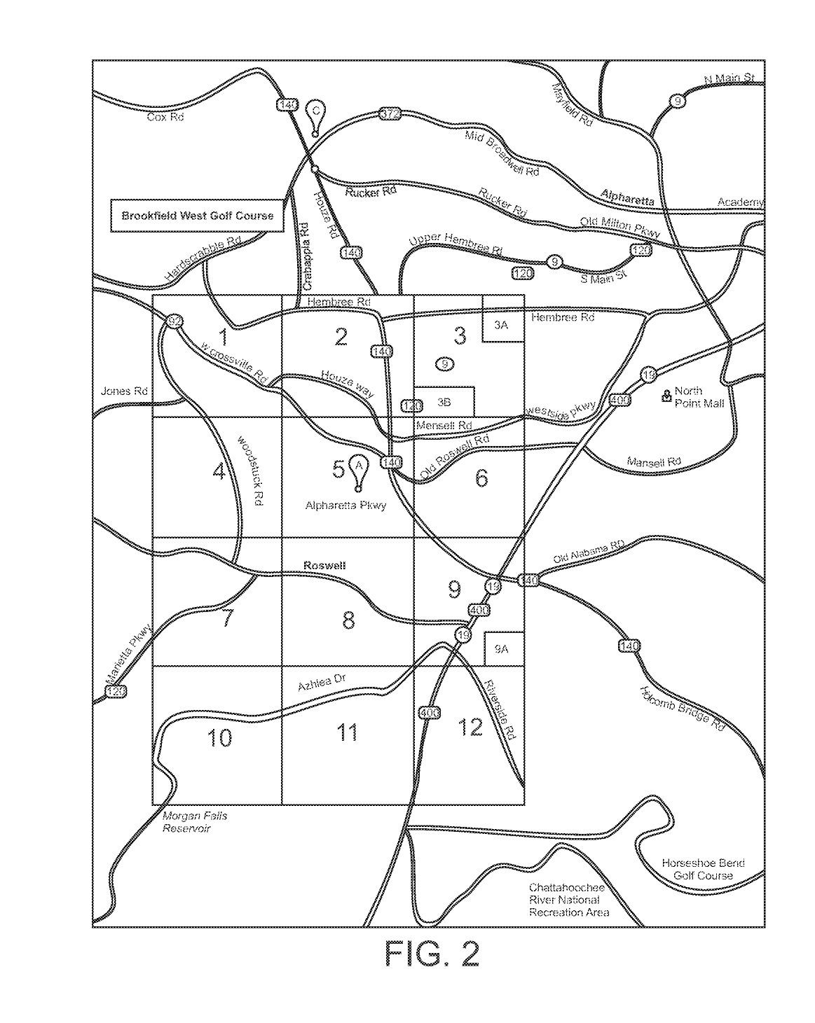

Referring now primarily to FIG. 2, a plot of land near the restaurant 4 or containing restaurant 4 shown in FIG. 1 may be subdivided into a desired number of zones. As shown in FIG. 2, zones one through twelve may be generally squared in shape or configuration. Zones may also be deployed or defined along major geographic features, such as roads, waterways, mountains and valleys and the like. FIG. 2 shows that the restaurant may be located in a zone, such as location “A” in zone 5, or not inside a zone, such as location “C.”

Notice also that zone 3 is further refined to create zone 3a and zone 3b. There could be a number of reasons to employ this technique and level of detail. For example, zone 3a could be known to include an apartment complex or business park with a desirable demand for pizza delivery. Likewise, zone 3b could define a so-called gated community or other area with a generally limited history of demand for delivery pizza or accessibility. The viewer will appreciate that the illustrated zone 3 includes three distinct portions, and zone 9 includes two distinct portions, including zone 9a.

The utility of the zones employed herein allow a more directed promotion campaign for the speculation pizzas. Greater direction is achieved, for example, by allowing the vehicle 12 to be closer to, and thus a shorter driving time, the speculation pizza ultimate delivery location. Knowing generally where the vehicle 12 is located, and where the vehicle 12 is destined, and the amount of time for the vehicle 12 to arrive will provide a more optimal production. Also, knowing which potential customers are located in which zone(s) allows for a more directed promotion campaign.

Optimal use of the zones might be achieved by educating a system operator (not shown), such as the driver (not shown) of the vehicle 12. For example, the driver of the vehicle 12 could be provided with maps and education to assist in determining when the vehicle 12 moves into and out of any particular zone, so as to generate an alert to potential buyers of the speculation pizza.

Optimal use of the zones might be achieved by use of a global positioning system (GPS) and one or more vehicles 12 having a GPS receiver. Basically, the GPS receiver operates in the vehicle 12 to locate a plurality of specific satellites, determine the distance to each satellite, and use this information to deduce its own relative location—usually based on the mathematical principle of trilateration. Knowing the location of the vehicle 12 and the location of the zones can facilitate knowing approximate travel distance and time.

Using radio signals, electromagnetic signals and the like, along with an operatively connected computer 5, the system 20 can properly determine the aggregate positions of one or more vehicles 12, the location of the vehicles relative to the desired zones, and which messages might be proper for broadcast. The term “computer” as used in this application may be understood to include but is not necessarily limited to any programmable machine that can execute a programmed list of instructions and respond to new instructions. Typically, the computer will include motherboard, CPU, memory (or RAM), hard drive, and video card coupled with a keyboard, touch screen (or other input means) and one or more video displays (or other output means).

In operation, speculation pizzas may be made by the restaurant 4 and sent out to be sold in one of at least two scenarios, or both:

a. Scenario One: With other ordered pizzas that go out for delivery.

b. Scenario Two: Speculation pizza(s) are taken to areas or buildings believed to have customers who would be willing to purchase the speculation pizza(s) if notified by the pizza store of their availability.

Customers who have agreed to participate in this marketing methodology (speculation pizzas) will be contacted electronically, such as for example a broadcast message, by one or more of the following means—text (SMS or MMS), email, phone call, and/or app (Apple, Android and the like) notification, to one or more of the customer's personal communications devices, such as for example, computer, smartphone, cell/PCS phone, iPad, tablet computer, and the like. In that message, the customer is notified by the restaurant 4 or the vehicle 12 of the availability of the speculation pizza(s) that are either en route to, or currently in, the general area or zone of the customer's home or place of work. A two way communication will take place between the customer and the restaurant 4 or the vehicle 12 whereby customers who are contacted and desire to purchase the pizza(s), can reply to the communication with the pizza store and can be delivered the pizza(s) along with any ancillary or complimentary food or drink products offered by the restaurant 4 or the vehicle 12. Customers will pay for the speculation pizza(s) and other products.

Proximity of the customer to the restaurant 4 or the vehicle 12 will promote operation of the system 20 and quantity of speculation pizzas delivered. Proximity may be measured in terms of either the number of minutes until delivery or distance to be traversed by the vehicle 12. For example, the initial broadcast message may go out to the customers whose homes (or offices) are within 20 minutes or 5 miles from the location of the ordered pizza customer's location—or within that ordered pizza customer's zone.

The restaurant 4 may send a vehicle 12 with speculation pizzas, to zones believed to have customers that will purchase the speculation pizza(s) in the hopes of selling speculation pizzas to customers by broadcasting messages to the customers in that zone. A zone may also be defined to include an office park, office building, apartment or condo building or development, college or university campus and surrounding housing, government building or campus, neighborhood, gated community, and the like.

The definitions herein are provided solely to facilitate an understanding of the Invention—not to limit the invention.

In operation, the process for promoting sales of a food item may include one or more of the steps of:
a) receiving an order for an ordered food item to be delivered to a first location;
b) sending a vehicle with the ordered food item towards the first location;
c) sending one or more secondary food items along with the vehicle;
d) preparing a list of the one or more secondary food items;
e) preparing a customer list of one or more customers;
f) broadcasting a first message including the list of secondary food items to one or more customers on the customer list;
g) receiving from a customer on the customer list of one or more customers a second message indicating the customer's desire to receive one or more secondary food items;
h) communicating to the customer on the customer list of one or more customers a third message indicating a willingness to deliver a secondary food item to the entry on the customer list; and
i) delivering a secondary food item to the customer on the customer list.

The invention may be made from any suitable material and by any suitable method. The invention may be adapted to fit a wide variety of uses. It will be appreciated that the components of the invention may be easily modified as needed to accommodate varying sizes and shapes.

It is to be understood that the invention is not limited in its application to the details of construction and to the arrangements of the components set forth in the accompanying description or illustrated in the drawings. The invention is capable of other embodiments and of being practiced and carried out in various ways. Also, it is to be understood that the phraseology and terminology employed herein are for the purpose of description and should not be regarded as limiting. The disclosure may readily be utilized as a basis for the designing of other structures, methods and systems for carrying out the present invention. It is important, therefore, that the claims be regarded as including equivalent constructions. Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract and disclosure are neither intended to define the invention of the application, which is measured by the claims, nor are they intended to be limiting as to the scope of the invention in any way.

What is claimed is:

1. A process for promoting sales of a food item comprising:
a) receiving an order for an ordered food item to be delivered to a first location;
b) sending a vehicle with the ordered food item towards the first location;
c) sending one or more secondary food items along with the vehicle;
d) preparing a list of the one or more secondary food items;
e) preparing a list of one or more customers; and
f) broadcasting a first message including the list of secondary food items to one or more customers on the list of one or more customers.

2. The process of claim 1 further comprising the step of delivering the ordered food item to the first location.

3. The process of claim 2 wherein the ordered food item is a pizza.

4. The process of claim 1 wherein the broadcasting a first message includes sending a text message.

5. The process of claim 1 further comprising receiving from a customer on the list of one or more customers a second message indicating the customer's desire to receive one or more secondary food items.

6. The process of claim 5 further comprising communicating to the customer on the list of one or more customers a third message indicating a willingness to deliver a secondary food item to the entry on the customer list.

7. The process of claim 6 further comprising delivering a secondary food item to the customer on the list of one or more customers.

8. The process of claim 1 further comprising sending a vehicle with the one or more secondary food items towards a second location.

9. The process of claim 8 further comprising the step of delivering the one or more secondary food items to the second location.

10. The process of claim 9 wherein the broadcasting a first message includes sending a text message.

11. A process for promoting sales of a food item comprising:
a) receiving an order for an ordered food item to be delivered to a first location;
b) sending a vehicle with the ordered food item towards the first location in a first zone;
c) sending one or more secondary food items with the vehicle;
d) preparing a list of the one or more secondary food items;
e) preparing a list of one or more customers; and
f) broadcasting a first message including the list of secondary food items to one or more customers on the customer list, wherein the one or more customers on the customer list are located in a second zone.

12. The process of claim 11 wherein the first zone and second zone are immediately adjacent on a grid.

13. The process of claim 11 further comprising sending a vehicle with the one or more secondary food items towards a second location.

14. The process of claim 11 further comprising the step of delivering the one or more secondary food items to the second location.

15. A process for promoting sales of a food item comprising:
a) sending one or more secondary food items with a vehicle towards a first location;
b) preparing a list of the one or more secondary food items;
c) preparing a list of one or more customers; and
d) broadcasting a first message including the list of secondary food items to one or more customers on the list of one or more customers.

16. The process of claim 15 further comprising sending a vehicle with the one or more secondary food items towards a second location.

17. The process of claim 15 further comprising the step of delivering the one or more secondary food items to the second location.

18. The process of claim 15 wherein the broadcasting a first message includes sending a text message.

19. The process of claim 15 wherein the one or more secondary food items is a pizza.

20. The process of claim 19 wherein the list of the one or more secondary food items includes a pizza.
